(19) United States
(12) Patent Application Publication
(10) Pub. No.: US 2025/0371239 A1
(43) Pub. Date: Dec. 4, 2025

(54) INTEGRATED CIRCUIT LAYOUT AND METHOD OF GENERATING THEREOF

(71) Applicant: Taiwan Semiconductor Manufacturing Company, Ltd., Hsinchu (TW)

(72) Inventors: Wei-Cheng Tzeng, Hsinchu City (TW); Ching-Yu Huang, Xinfeng Township (TW); Kuan Yu Chen, Xinfeng Township (TW); Wei-Cheng Lin, Xinfeng Township (TW); Jiann-Tyng Tzeng, Xinfeng Township (TW)

(73) Assignee: Taiwan Semiconductor Manufacturing Company, Ltd., Hsinchu (TW)

(21) Appl. No.: 18/675,897

(22) Filed: May 28, 2024

(51) Int. Cl. G06F 30/392; G06F 111/04

(52) U.S. Cl. CPC G06F 30/392; G06F 2111/04

(57) ABSTRACT

An integrated circuit layout includes at least a cell area, which includes a plurality of cell rows extending along a first direction and each having a uniform row height along a second direction perpendicular to the first direction. The cell area consists of a first area and a second area directly abutting the first area along the second direction. The first area includes a plurality of first channels of p-type and n-type extending along the first direction and separated from each other along the second direction, and each having a first channel height along the second direction. The second area includes a plurality of second channels of p-type and n-type extending along the first direction and separated from each other along the second direction, and each having a second channel height different from the first channel height along the second direction.

### BACKGROUND

Generally, electronic design automation (EDA) tools assist semiconductor designers to take a purely behavioral description of a desired circuit and work to fashion a finished layout of the circuit ready to be manufactured. This process usually takes the behavioral description of the circuit and turns it into a functional description, which is then decomposed into a number of Boolean functions and mapped into respective cell rows using a standard cell library. Once mapped, a synthesis is performed to turn the structural design into a physical layout, a clock tree is built to synchronize the structural elements, and the design is optimized post layout.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a schematic diagram of an example integrated circuit layout in accordance with some embodiments.

FIG. 2 illustrates a schematic diagram of a portion of the integrated circuit of FIG. 1 at a certain metallization level in accordance with some embodiments.

FIG. 3 illustrates a schematic diagram of a cell area of a plurality of cell areas included in the integrated circuit layout of FIG. 1 in accordance with some embodiments.

FIG. 4 illustrates a schematic diagram of another call area of a plurality of cell areas included in the integrated circuit layout of FIG. 1 in accordance with other embodiments.

FIG. 5 illustrates a flow chart of an example method of generating an integrated circuit layout including one or more cell areas having hybrid active regions (HBOs) in accordance with some embodiments.

FIG. 6 illustrates a schematic diagram of a portion of a netlist in accordance with some embodiments.

FIG. 7 illustrates a block diagram of an example information handling system (HIS) in accordance with some embodiments.

FIG. 8 illustrates a schematic diagram showing an HBO cell area abutting a uniform-row cell (or a uni-row cell) in accordance with some embodiments.

FIG. 9 illustrates a schematic diagram showing a cell area having an HBO configuration abutting two uni-row cells in accordance with some embodiments.

FIG. 10 illustrates a cross-sectional view of a portion of a cell formed in the cell area as shown in FIG. 3 in accordance with some embodiments.

FIG. 11 illustrates a schematic diagram that shows placements of conductive vias in a plurality of cell areas in the integrated circuit layout of FIG. 1 in accordance with some embodiments.

FIG. 12 illustrates a schematic diagram of an example integrated circuit layout for a SDFQ integrated circuit at a certain metallization level in accordance with some embodiments.

FIG. 13 illustrates a schematic diagram of an example integrated circuit layout for a TxG integrated circuit at a certain metallization level in accordance with some embodiments.

FIG. 14 illustrates a schematic diagram of still another example integrated circuit layout including multi-stage cells at a certain metallization level in accordance with some embodiments.

FIG. 15 illustrates a schematic diagram of an example integrated circuit layout including a combination of HBO cells and uni-row cells in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In practice, some integrated circuits (ICs) are more performance-orientated, while other integrated circuits are more power/area-orientated, for example. As such, to design an integrated circuit that consumes low power and occupies a small area without sacrificing its performance (e.g., a balance-orientated circuit), various design compromises are typically made. In designing integrated circuits, larger active regions (ODs) width may bring higher speed, energy consumption, and leakage, and tuning an OD width is more efficient than tuning gate (PO) numbers. Larger ODs with less PO numbers may have better speed and energy performance compared to smaller ODs with more PO numbers.

The present disclosure provides various embodiments of integrated circuit layouts. In accordance with some embodiments, an integrated circuit layout includes a space arranged for the integrated circuit layout, and at least one cell area arranged in the space. The cell area includes a plurality of uniform cell rows extending along a first direction. Each of the plurality of uniform cell rows has a uniform row height along a second direction perpendicular to the first direction. The cell area consists of a first area including a plurality of first channels of p-type and n-type extending across the space along the first direction and separated from each other along the second direction, and a second area directly abutting the first area along the second direction and including a plurality of second channels of p-type and n-type extending across the space along the first direction and separated from each other along the second direction. Each of the plurality of first channels has a first channel height along the second direction, and each of the plurality of second channels has a second channel height different from the first channel height along the second direction. As such, the cell area of the integrated circuit layout has a hybrid active region (“hybrid OD” or “HBO”) configuration with hybrid channel heights.

In accordance with some embodiments, the second channel height is greater than the first channel height, and a source/drain terminal of a first channel of the plurality of first channels in the first area and a corresponding source/drain terminal of a second channel of the plurality of second channels in the second area are commonly connected to a power line or a signal line through a common via that is placed adjacent to the second channel.

Various advantages may be presented by the integrated circuit layout that utilizes the HBO configuration. Among other things, the HBO configurations of the cell areas of the integrated circuit layout, and the arrangement or placement of a common via of two commonly connected HBO channels can advantageously result in improved average speed, lower power consumption, and an area-efficient connection to the power line or the signal line, thereby achieving improved performance of the integrated circuit.

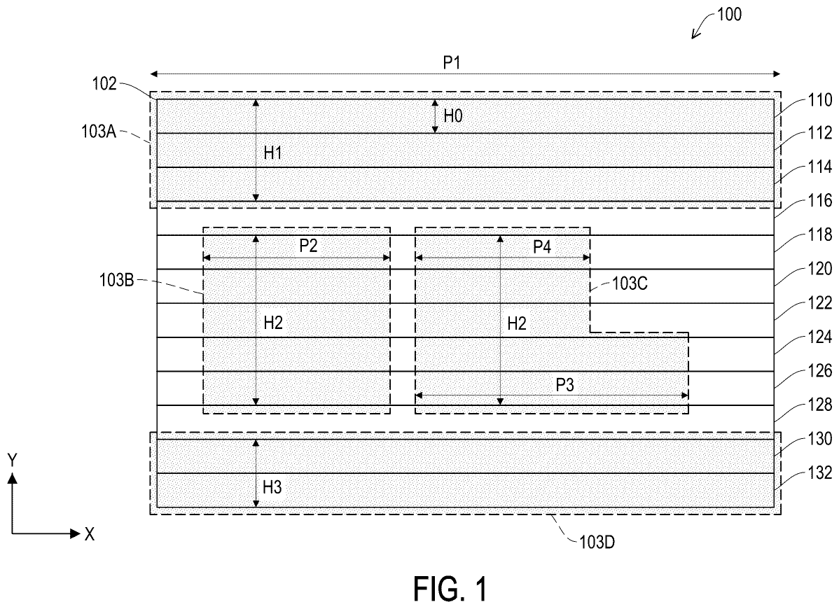

FIG. 1 illustrates a schematic diagram of an example integrated circuit or integrated circuit layout 100 designed by systems and methods of the present disclosure in accordance with some embodiments. Not all of the illustrated components are required, however, and some embodiments of the present disclosure may include additional components not shown in FIG. 1. Variations in the arrangement and type of the components may be made without departing from the scope of the present disclosure as set forth herein. Additional, different, or fewer components may be included.

Referring to FIG. 1, the integrated circuit layout 100 includes a plurality of uniform cell rows 110, 112, 114, 116, 118, 120, 122, 124, 126, 128, 130 and 132 arranged (e.g., laid out) across along a first direction (the X direction) and with respect to a space, grid, or floorplan 102 that is arranged for a design of the integrate circuit layout 100. In some embodiments, each of the uniform cell rows 110-132 of the integrated circuit layout 100 may present a uniform (or identical) row height H0 along a second direction (the Y direction) perpendicular to the first direction. Such a uniform row height H0 corresponds to a uniform cell height of a cell (sometimes referred to as a standard cell) to be placed therein, which shall be discussed below.

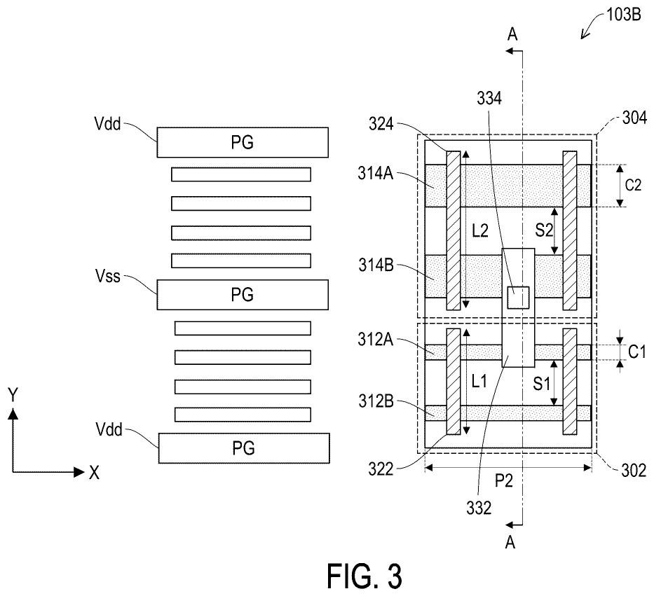

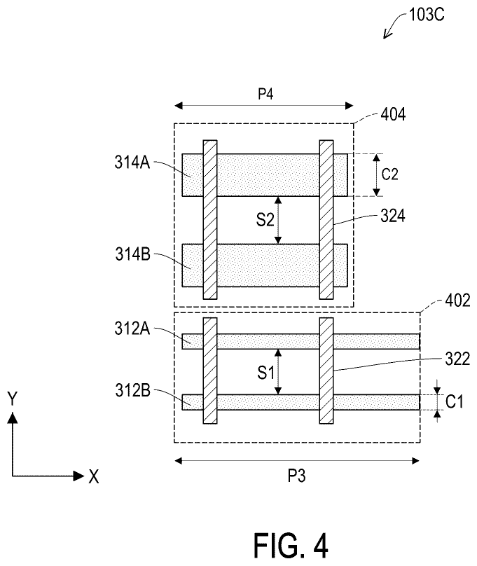

As shown in FIG. 1, the integrated circuit layout 100 can arrange a plurality of contiguous cell areas (such as 103A, 103B, 103C and 103D), and each of the plurality of contiguous cell areas consists of two or more uniform cell rows extending partially or completely across the space 102 along the first direction. For example, the contiguous cell area 103A consists of (or expanded by) three cell rows 110, 112 and 114, each of which completely extends across the space 102 along the first direction; the contiguous cell area 103B consists of (or expanded by) five cell rows 118, 120, 122, 124 and 126, each of which partially extends across the space 102 along the first direction; the contiguous cell area 103C consists of (or expanded by) five cell rows 118, 120, 122, 124 and 126, each of which partially extends across the space 102 along the first direction; and the contiguous cell area 103D consists of (or expanded by) two cell rows 130 and 132, each of which completely extends across the space 102 along the first direction. Thus, the contiguous cell area 103A has a cell area pitch P1 along the first direction, and a cell area heigh H1 along the second direction, H1=3×H0; the contiguous cell area 103B has a cell area pitch P2 along the first direction, and a cell area heigh H2 along the second direction, H2=5×H0; the contiguous cell area 103C has a first cell area pitch P3 for its first part and a second cell area pitch P4 for its second part along the first direction, and a cell area heigh H2 along the second direction, H2=5×H0; and the contiguous cell area 103D has a cell area pitch P1 along the first direction, and a cell area heigh H3 along the second direction, H3=2×H0. As such, some contiguous cell areas (e.g., 103B and 103C) can be called tall cell areas, and other contiguous cell areas (e.g., 103D) can be called short cell areas. Details about the configurations and arrangements of the contiguous cell areas will be explained later with respect to FIGS. 3 and 4.

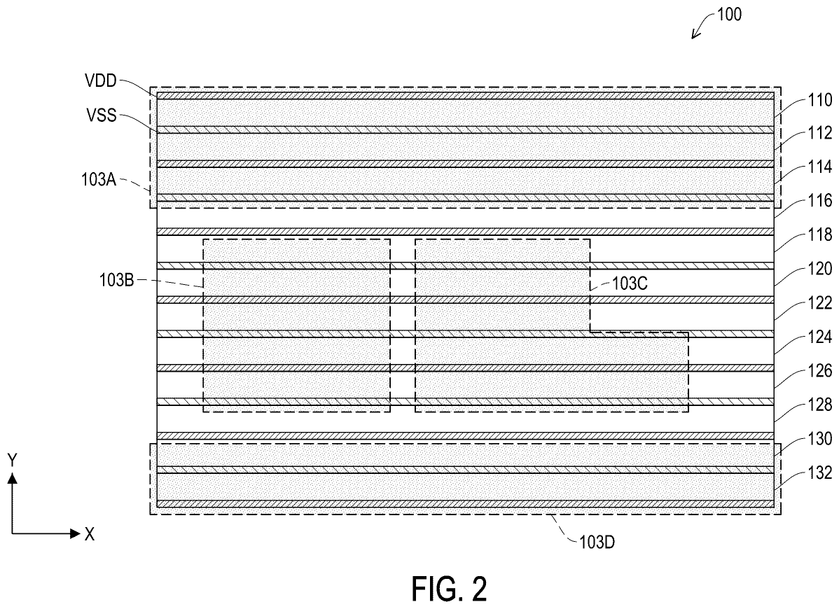

FIG. 2 illustrates a schematic diagram of a portion of the integrated circuit 100 of FIG. 1 at a certain metallization level in accordance with some embodiments. A schematic diagram of a portion of the integrated circuit 100 at a certain metallization level (e.g., an M0 level) is shown, in accordance with some embodiments. As shown, each uniform cell row, along a second direction (the Y direction) perpendicular to the first direction (the X direction), is bounded at respective sides with a first metal rail and a second metal rail. The first metal rail can be a VDD power rail configured to provide VDD to each of the cells that are placed within the cell row, and the second metal rail can be a VSS power rail configured to provide VSS to each of the cells that are placed within the cell row.

As shown in FIG. 2, the cell rows, adjacent to each other along the second direction, may combine, abut, or otherwise share the same VDD power rail or VSS power rail. For example, cell row 110 may share the same VSS power rail as cell row 112. As the VDD/VSS power rail may extend along the corresponding uniform cell row, it is appreciated that some of the VDD/VSS power rails may completely extend across the space 102 along the X direction (e.g., the VSS power rail shared by cell rows 110 and 112) as shown in FIG. 2 in some embodiments, while the other VDD/VSS power rails may partially extend across the space 102 along the X direction (not shown) in other embodiments.

In some embodiments, one or more contiguous cell areas, such as 103A, 103B, 103C and 103D, in the space 102 of the integrated circuit 100 as shown in FIG. 2 correspond one or more circuit modules. The integrated circuit can arrange such contiguous cell areas based on identified circuit modules of the integrated circuit. For example, a circuit module may be identified or selected based on determining that the circuit module was previously specified (e.g., user-specified) as a performance-oriented circuit module. In another example, a circuit module may be identified based on determining that the circuit module was previously specified as a power-oriented circuit module.

The circuit module, as discussed herein, may refer to a set of circuit components that is configured to perform a certain function. For example, the integrated circuit can include a central processing unit (CPU), a graphic processing unit (GPU), an input/output (I/O) interface, and a memory. As such, a plurality of circuit modules, each of which can perform a certain function (e.g., calculation, reception of instruction, etc.), can collectively form the CPU. The integrated circuit or system can arrange such a contiguous cell area based on at least one of an identified timing constraint, an identified performance constraint, or an identified power constraint that can be shared by the cells disposed in the contiguous cell area. It is appreciated that such cells does not necessarily correspond to a same circuit module. In some embodiments, such a shared timing/performance/power constraint may be specified by the design or identified by performing one or more simulations on the circuit design of the integrated circuit using circuit simulators, for example, Simulation Program with Integrated Circuit Emphasis (SPICE).

FIG. 3 illustrates a schematic diagram of a contiguous cell area (e.g., 103B) of a plurality of contiguous cell areas (such as 103A, 103B, 103C and 103D) included in the integrated circuit layout 100 of FIG. 1 in accordance with some embodiments. As shown in FIG. 1, a contiguous cell area 103B is arranged in a space 102 that includes a plurality of uniform cell rows (e.g., 110, 112, 114, 116, 118, 120, 122, 124, 126, 128, 130, and 132). Each uniform cell row (e.g., 110) of the plurality of uniform cell rows extends along a first direction (the X direction) in the space 102 and has a uniform row height H0 along a second direction (the Y direction) perpendicular to the first direction.

In some embodiments, as shown in FIG. 1, a cell area (e.g., 103B) includes a plurality of uniform cell rows extending along the first direction (the X direction), each of the plurality of uniform cell rows having a uniform row height along a second direction perpendicular to the first direction. As shown in FIG. 1, for example, the cell area 103B includes five uniform cell rows 118, 120, 122, 124 and 126 all extending along the first direction (the X direction), each of the five uniform cell rows having a uniform row height H0 along the second direction (the Y direction).

In some embodiments, as shown in FIG. 3, the cell area (e.g., 103B) consists of a first area including a plurality (two or more) of first channels of p-type and n-type extending across the cell area along the first direction (the X direction) and separated from each other along the second direction (the Y direction), each of the plurality of first channels having a first channel height along the second direction; and a second area directly abutting the first area along the second direction, and comprising a plurality (two or more) of second channels of p-type and n-type extending across the cell area along the first direction and separated from each other along the second direction, each of the plurality of second channels having a second channel height along the second direction, the second channel height being different from the first channel height.

Referring to FIGS. 1 and 3, for example, the cell area 103B consists of a first area 302 and a second area 304 directly abutting the first area along the second direction. The first area 302 includes e.g., two first channels 312 (e.g., 312A and 312B) of p-type and n-type extending across the cell area 103B by a pitch P2 (also shown in FIG. 1) along the first direction (the X direction) and separated from each other by a distance S1 along the second direction (the Y direction). Each of the first channels has a first channel height C1 along the second direction. The second area 304 includes e.g., two second channels 314 (e.g., 314A and 314B) of p-type and n-type extending across the cell area 103B by the pitch P2 (also shown in FIG. 1) along the first direction and separated from each other by a distance S2 along the second direction. Each of the plurality of second channels has a second channel height C2 along the second direction. The second channel height C2 is different from the first channel height C1. In some embodiments, as shown in FIG. 3, the second channel height C2 is greater than the first channel height C1.

As shown in FIG. 3, the first area 302 of the cell area 103B includes at least one gate structure 322 extending along the second direction (the Y direction) by a first length L1 across the first channels 312A and 312B, and thus at least partially wrapping the first channels 312A and 312B; and the second area 304 of the cell area 103B includes at least one gate structure 324 extending along the second direction (the Y direction) by a second length L2 across the second channels 314A and 314B, and thus at least partially wrapping the first channels 314A and 314B.

In some embodiments, the first area 302 is configured to place a plurality of first circuit modules, and the second area 304 is configured to place a plurality of second circuit modules. In some embodiments, the plurality of first circuit modules share at least one of a first timing constraint, a first performance constraint, or a first power constraint, and the plurality of second circuit modules share at least one of a second timing constraint, a second performance constraint, or a second power constraint.

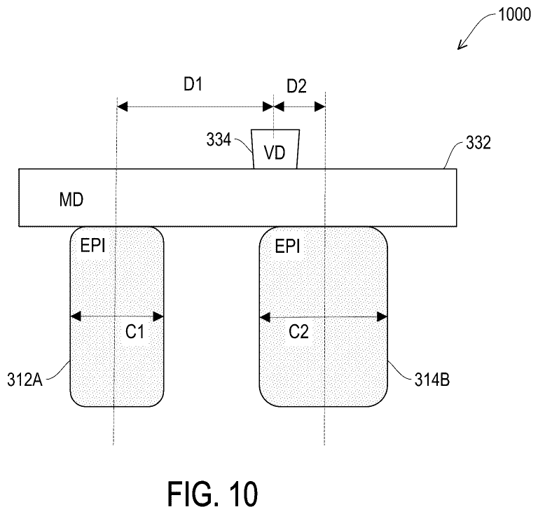

As shown in FIG. 3, for example, a source/drain terminal (as shown in FIG. 10) of a first channel 312A in the first area 302 and a corresponding source/drain terminal (as shown in FIG. 10) of a second channel 314B in the second area 304 are commonly connected by a conductive line 332. Some source/drain terminals of the channels are connected to power grounds (PGs). In some embodiments, the conductive line 332 is connected to a power line (VDD or VSS) through a conductive via 334 that is placed adjacent to, partially over, or directly over the second channel 314B having a second channel height C2 greater than the first channel height C1. In other embodiments, the conductive line 332 is connected to a signal line (not shown) through the conductive via 334 that is placed adjacent to, partially over, or directly over the second channel 314B having a second channel height C2 greater than the first channel height C1.

FIG. 4 illustrates a schematic diagram of another contiguous cell area (e.g., 103C) of a plurality of cell areas included in the integrated circuit layout 100 of FIG. 1 in accordance with other embodiments. As shown in FIG. 1, the contiguous cell area 103C is also arranged in a space 102 that includes a plurality of uniform cell rows (e.g., 110, 112, 114, 116, 118, 120, 122, 124, 126, 128, 130, 132). Each uniform cell row (e.g., 110) of the plurality of uniform cell rows in the space 102 extends along a first direction (the X direction) and has a uniform row height H0 along a second direction (the Y direction) perpendicular to the first direction. The contiguous cell area 103C is similar to the contiguous cell area 103B in some aspect but has exceptions.

Referring to FIGS. 1 and 4, the cell area 103C consists of a first area 402 and a second area 404 directly abutting the first area along the second direction. The first area 402 includes e.g., two first channels 312 (e.g., 312A and 312B) of p-type and n-type extending across the cell area 103B by a first pitch P3 (also shown in FIG. 1) along the first direction (X direction) and separated from each other by a first distance S1 along the second direction (Y direction). Each of the first channels 312 has a first channel height C1 along the second direction. The second area 404 includes e.g., two second channels 314 (e.g., 314A and 314B) of p-type and n-type extending across the cell area 103B by a second pitch P4 (also shown in FIG. 1) along the first direction and separated from each other by a second distance S2 along the second direction. Each of the plurality of second channels 314 has a second channel height C2 different from the first channel height C1 along the second direction. The first pitch P3 of the first area 402 and the second pitch P4 of the second area 404 are different, and thus the cell area 103C has an L-shaped profile, thereby providing more flexibilities to the arrangements of the cell areas.

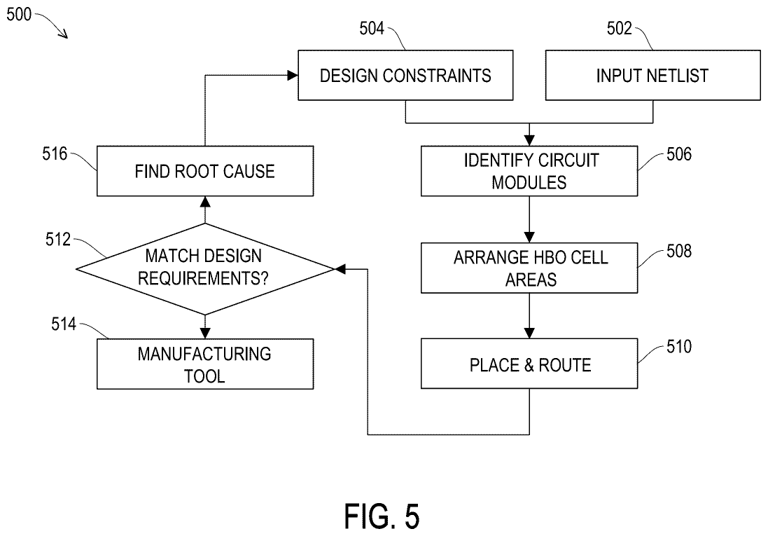

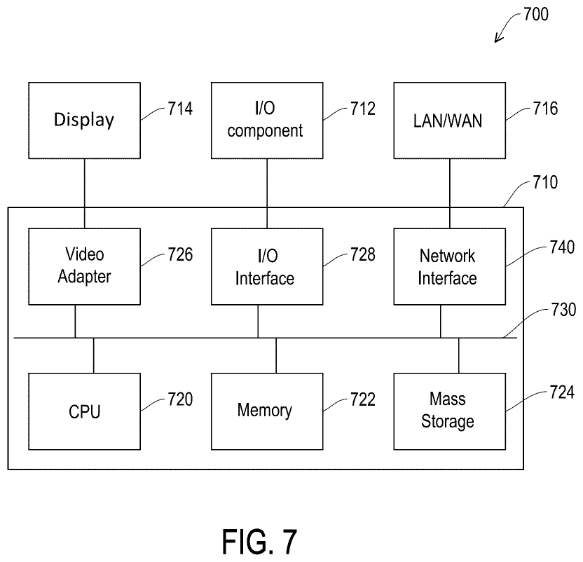

FIG. 5 illustrates a flow chart of an example method 500 of generating an integrated circuit layout including one or more cell areas having hybrid active regions (HBOs) in accordance with some embodiments. Active regions can be called ODs, and thus hybrid active regions can be called HBOs. In some embodiments, the method 500 may be collectively referred to as an EDA. The operations of the method 500 are performed by the respective components illustrated in FIG. 7. For purposes of discussion, the following embodiment of the method 500 will be described in conjunction with FIG. 7. The illustrated embodiment of the method 500 is merely an example. Therefore, it is understood that any of a variety of operations may be omitted, re-sequenced, and/or added while remaining within the scope of the present disclosure.

The method 500 starts with provision operations of “input netlist 502,” and “design constraints 504,” in accordance with some embodiments. The input netlist 502 may be a functionally equivalent logic gate-level circuit description provided through a synthesis process. The synthesis process forms the functionally equivalent logic gate-level circuit description by matching one or more behavior and/or functions to (standard) cells from a set of cell libraries. The behavior and/or functions are specified based upon various signals or stimuli applied to the inputs of an overall design of the integrated circuit (e.g., the integrated circuit 100), and may be written in a suitable language, such as a hardware description language (HDL). The input netlist 502 may be uploaded into the processing unit 710 through the I/O interface 728 (in FIG. 7), such as by a user creating the file while the EDA is executing. Alternately, the input netlist 502 may be uploaded and/or saved on the memory 722 or mass storage device 724, or the input netlist 502 may be uploaded through the network interface 740 from a remote user (in FIG. 7). In these instances, the CPU 720 shall access or interface with the input netlist 502 during execution of the EDA.

The user also provides the design constraints 504 in order to constrain the overall design of a physical layout of the input netlist 502. In some embodiments, the design constraints 504 may be input, for example, through the I/O interface 728, downloading through the network interface 740, or the like (in FIG. 7). The design constraints 504 may specify timing, process parameters, and other suitable constraints with which the input netlist 502, once physically formed into an integrated circuit, must comply.

The method 500 proceeds to operation 506 to “identify circuit modules,” in accordance with some embodiments. Based on the input netlist 502 and/or the design constraints 504, the disclosed system can recognize, identify, or otherwise determine one or more circuit modules that are specified by the user, for example, to be constituted by the HBO cells with a tall height (hereinafter “tall HBO cells”), the HBO cells with a short height (hereinafter “short HBO cells”), or the HBO cells with L-shaped profiles (hereinafter “L-shaped HBO cells”).

For example, the system may identify a first circuit module in response to the input netlist 502 specifying that the first circuit module is a performance-orientated circuit module, which shall consist of the tall HBO cells. In another example, the system may identify a second circuit module in response to the input netlist 502 specifying that the second circuit module is a power-orientated circuit module, which shall consist of the short HBO cells. Alternately or additionally, the system can identify a circuit module, which shall consist of tall or short HBO cells, by determining at least one of a timing constraint, a performance constraint, or a power constraint corresponding to the circuit module. The system can access, communicate with, or otherwise interface with the design constraints 504 to determine such timing/performance/power constraint(s). In some embodiments, the system can identify, based on the input netlist 502, one or more circuit modules that shall not consist of only the tall or short cells. Continuing with the above example, the system may identify a third circuit module in response to the input netlist 502 specifying that the third circuit module has a more flexible profile.

The method 500 proceeds to operation 508 to “arrange HBO cell areas” in accordance with some embodiments. In response to identifying one or more circuit modules that shall consist of either the tall, short, or L-shaped HBO cells (e.g., in the operation 506), the system can arrange corresponding HBO cell areas. Also referring to FIG. 1, each of the plurality of contiguous cell areas (such as 103A, 103B, 103C and 103D) consists of two or more uniform cell rows extending partially or completely across the space 102 along the first direction. For example, the contiguous cell area 103A consists of (or expanded by) three cell rows 110, 112 and 114, each of which completely extends across the space 102 along the first direction; the contiguous cell area 103B consists of (or expanded by) five cell rows 118, 120, 122, 124 and 126, each of which partially extends across the space 102 along the first direction; the contiguous cell area 103C consists of (or expanded by) five cell rows 118, 120, 122, 124 and 126, each of which partially extends across the space 102 along the first direction; and the contiguous cell area 103D consists of (or expanded by) two cell rows 130 and 132, each of which completely extends across the space 102 along the first direction. Thus, the contiguous cell area 103A has a pitch P1 along the first direction, and a cell area heigh H1 along the second direction, H1=3×H0; the contiguous cell area 103B has a pitch P2 along the first direction, and a cell area heigh H2 along the second direction, H2=5×H0; the contiguous cell area 103C has a first pitch P3 for its first part and a second pitch P4 for its second part along the first direction (thus having an L-shaped profile), and a cell area heigh H2 along the second direction, H2=5×H0; and the contiguous a cell rea 103D has a pitch P1 along the first direction, and a cell area heigh H3 along the second direction, H3=2×H0. Also referring to FIG. 3, each cell area consists of a first area including a plurality (two or more) of first channels of p-type and n-type extending across the cell area along the first direction (the X direction) and separated from each other along the second direction (the Y direction), each of the plurality of first channels having a first channel height along the second direction; and a second area directly abutting the first area along the second direction, and comprising a plurality (two or more) of second channels of p-type and n-type extending across the cell area along the first direction and separated from each other along the second direction, each of the plurality of second channels having a second channel height different from the first channel height along the second direction. As such, some contiguous cell areas (e.g., 103B and 103C) are tall (thus can be called tall HBO cell areas), some contiguous cell areas (e.g., 103D) are short (thus can be called short HBO cell areas), and some contiguous cell areas (e.g., 103C) have L-shaped profiles (thus can be called L-shaped HBO cell areas).

The method 500 proceeds to operation 510 to “place and route,” in accordance with some embodiments. In response to arranging the tall and/or short HBO cell areas for respective circuit modules, the system can place and route cells to generate an actual physical design for the overall integrated circuit. The operation 510 is configured to form the physical design by taking the chosen cells from cell libraries and placing them into respective cell rows. The placement of each cell within the cell rows, and the placement of each cell row in relation to other cell rows, may be guided by cost functions in order to minimize wiring lengths and cell area requirements of the resulting integrated circuit. This placement may be done either automatically through the operation 510, or else may alternately be performed partly through a manual process, whereby the user may manually insert one or more cells into a cell row.

The method 500 then proceeds to operation 512 to determine whether the actual physical design for the overall integrated circuit “match design requirements,” in accordance with some embodiments. In response to generating the actual physical design for the overall integrated circuit (in the operation 510), the system can check, monitor, or otherwise determine whether the design requirements are matched. Various requirements may be checked such as, for example, a timing quality of the actual physical design for the overall integrated circuit, a power quality of the actual physical design for the overall integrated circuit, whether a local congestion issue exists, etc., by performing one or more simulations using circuit simulators, e.g., Simulation Program with Integrated Circuit Emphasis (SPICE).

If all the design requirements are met, the method 500 continues to operation 514 of “manufacturing tool.” On the other hand, if not all of the design requirements are met, the method 500 continues to operation 516 of “find root causes.”

The system can perform the operation 516 to find the causes resulting in the failure of meeting the design requirements in the determination operation 512. Various causes may result in the failure. Based on which of the causes is or are, the method 500 may proceed to a respective operation to re-perform that operation. For example, when the cause is due to an incorrect arrangement of cell row(s), the method 500 may proceed to an operation (e.g., the operation 504) to re-assess the constraints specified therein. When the cause is due to an infeasibility of synthesizing the functionally equivalent logic gate-level circuit description, the method 500 may proceed to an operation (e.g., the operation 504) to re-assess the constraints specified therein. When cause is due to an infeasibility of generating the actual physical design, the method 500 may proceed to an operation (e.g., the operation 510) to re-place and/or re-route.

The system can perform the manufacturing tool 514 to generate, e.g., photolithographic masks, which may be used in physically manufacturing the physical design. The physical design may be sent to the manufacturing tool 514 through the LAN/WAN 716.

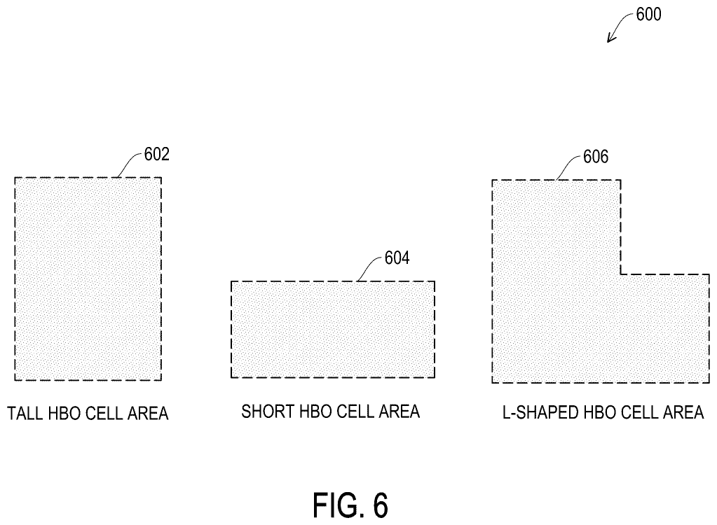

FIG. 6 illustrates a schematic diagram of a portion of a netlist in accordance with some embodiments. As shown in FIG. 6, a portion of a netlist (during synthesis) 600, which can be one of the above-described windows, includes for example “tall HBO cell areas” 602, “short HBO cell areas” 604, and “L-shaped HBO cell areas” 606.

Also referring to FIG. 1, each of the plurality of contiguous cell areas (such as 103A, 103B, 103C and 103D) consists of two or more uniform cell rows extending partially or completely across the space 102 along the first direction. For example, the contiguous cell area 103A consists of (or expanded by) three cell rows 110, 112 and 114, each of which completely extends across the space 102 along the first direction; the contiguous cell area 103B consists of (or expanded by) five cell rows 118, 120, 122, 124 and 126, each of which partially extends across the space 102 along the first direction; the contiguous cell area 103C consists of (or expanded by) five cell rows 118, 120, 122, 124 and 126, each of which partially extends across the space 102 along the first direction; and the contiguous cell area 103D consists of (or expanded by) two cell rows 130 and 132, each of which completely extends across the space 102 along the first direction. Thus, the contiguous HBO cell area 103A has a pitch P1 along the first direction, and a cell area heigh H1 along the second direction, H1=3×H0 (short HBO cell area); the contiguous cell area 103B has a pitch P2 along the first direction, and a cell area heigh H2 along the second direction, H2=5×H0 (tall HBO cell area); the contiguous cell area 103C has a first pitch P3 for its first part and a second pitch P4 for its second part along the first direction (thus having an L-shaped profile), and a cell area heigh H2 along the second direction, H2=5×H0 (tall HBO cell area); and the contiguous cell area 103D has a pitch P1 along the first direction, and a cell area heigh H3 along the second direction, H3=2×H0 (short HBO cell area). As such, some contiguous cell areas (e.g., 103B and 103C) are tall (thus can be called tall HBO cell areas), and other contiguous HBO cell areas (e.g., 103D) are short (thus can be called short HBO cell areas).

Also referring to FIG. 3, each cell area consists of a first area including a plurality (two or more) of first channels of p-type and n-type extending across the cell area along the first direction (the X direction) and separated from each other along the second direction (the Y direction), each of the plurality of first channels having a first channel height along the second direction; and a second area directly abutting the first area along the second direction, and comprising a plurality (two or more) of second channels of p-type and n-type extending across the cell area along the first direction and separated from each other along the second direction, each of the plurality of second channels having a second channel height different from the first channel height along the second direction.

Referring now to FIG. 7, a block diagram of an information handling system (IHS) 700 is provided, in accordance with some embodiments of the present invention. The IHS 700 may be a computer platform used to implement any or all of the processes discussed herein to design an integrated circuit. The HIS 700 may comprise a processing unit 710, such as a desktop computer, a workstation, a laptop computer, or a dedicated unit customized for a particular application. The HIS 700 may be equipped with a display 714 and one or more input/output (I/O) components 712, such as a mouse, a keyboard, or printer. The processing unit 710 may include a central processing unit (CPU) 720, memory 722, a mass storage device 724, a video adapter 726, and an I/O interface 728 connected to a bus 730.

The bus 730 may be one or more of any type of several bus architectures including a memory bus or memory controller, a peripheral bus, or video bus. The CPU 720 may comprise any type of electronic data processor, and the memory 722 may comprise any type of system memory, such as static random access memory (SRAM), dynamic random access memory (DRAM), or read-only memory (ROM).

The mass storage device 724 may comprise any type of storage device configured to store data, programs, and other information and to make the data, programs, and other information accessible via the bus 730. The mass storage device 724 may comprise, for example, one or more of a hard disk drive, a magnetic disk drive, an optical disk drive, or the like.

The video adapter 726 and the I/O interface 728 provide interfaces to couple external input and output devices to the processing unit 710. As illustrated in FIG. 7, examples of input and output devices include the display 714 coupled to the video adapter 726 and the I/O components 712, such as a mouse, keyboard, printer, and the like, coupled to the I/O interface 728. Other devices may be coupled to the processing unit 710, and additional or fewer interface cards may be utilized. For example, a serial interface card (not shown) may be used to provide a serial interface for a printer. The processing unit 710 also may include a network interface 740 that may be a wired link to a local area network (LAN) or a wide area network (WAN) 716 and/or a wireless link.

It should be noted that the HIS 700 may include other components/devices. For example, the HIS 700 may include power supplies, cables, a motherboard, removable storage media, cases, and the like. These other components/devices, although not shown, are considered part of the HIS 700.

In some embodiments of the present invention, an Electronic Design Automation (EDA) is program code that is executed by the CPU 720 to analyze a user file to obtain the layout of an integrated circuit (e.g., the integrated circuit layout 100 discussed above). Further, during the execution of the EDA, the EDA may analyze functional components of the layout, as is known in the art. The program code may be accessed by the CPU 720 via the bus 730 from the memory 722, mass storage device 724, or the like, or remotely through the network interface 740.

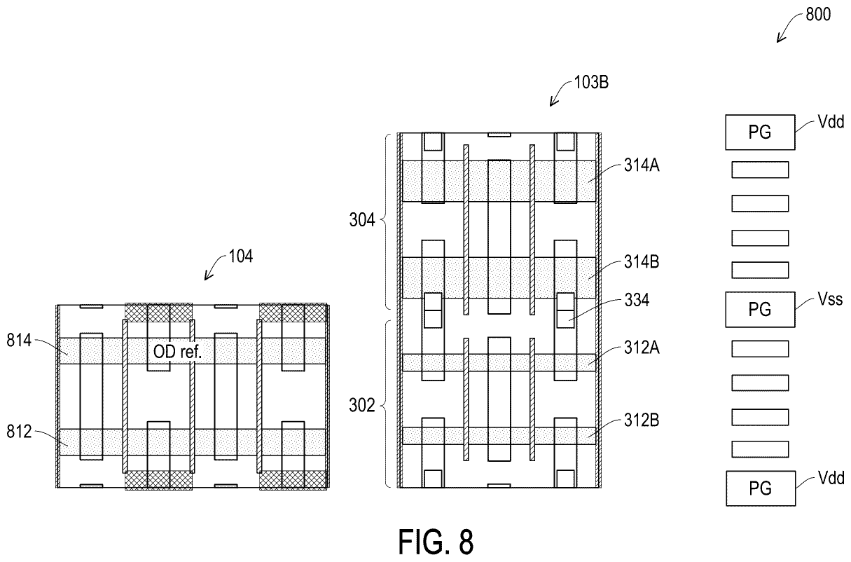

FIG. 8 illustrates a schematic diagram 800 showing an HBO cell area 103B abutting a uniform-row cell (or uni-row cell) 104 in accordance with some embodiments. As shown in FIGS. 3 and 8, the cell area 103B includes a first area 302 and a second area 304 directly abutting the first area along the second direction; the first area 302 includes a pair of first channels 312A and 312B each having a first channel height C1 along the second direction; the second area 304 includes a pair of second channels 314A and 314B each having a second channel height C2 along the second direction; the second channel height C2 is different from the first channel height C1, and both of the first channel height C1 and the second channel height C2 can be adjustable. In some embodiments, the first and the second channel heights Ca and C2 are able to be adjusted based on the function requirements of the circuit components. As shown in FIG. 8, the uni-row cell 104 has a pair of channels 812A and 812B both have the same channel height. In some embodiments, the HBO cell area 103B directly abuts the uni-row cell 104, and in other embodiments, the HBO cell area 103B is adjacent to and separated from the uni-row cell 104.

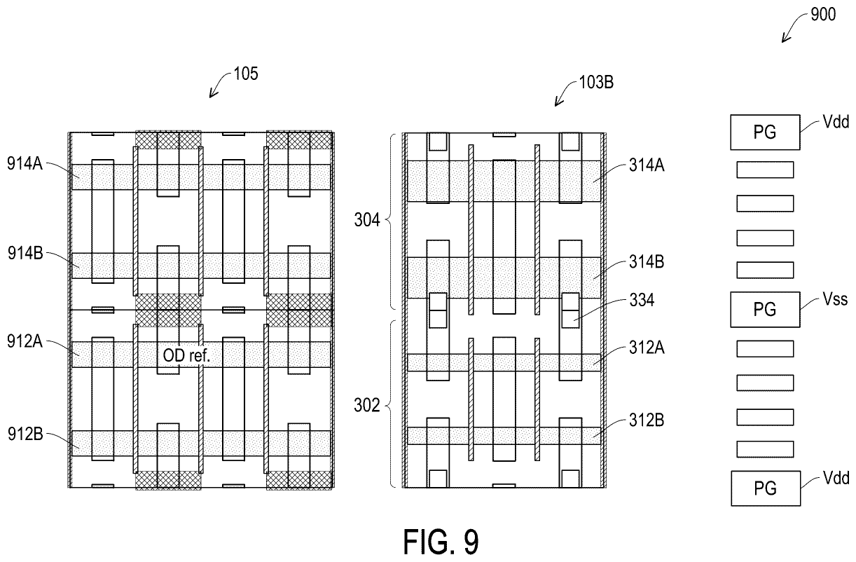

FIG. 9 illustrates another schematic diagram 900 showing an HBO cell area 103B abutting another uni-row cell 105 in accordance with some embodiments. The uni-row cell 105 is similar to the uni-row cell 104 but has differences. As shown in FIG. 9, the uni-row cell 105 has a first pair of channels 912A and 912B, and a second pair of channels 914A and 914B, all of the channels such as 912A, 912B, 914A and 914B have the same channel height. In some embodiments, the HBO cell area 103B directly abuts the uni-row cell 105, and in other embodiments, the HBO cell area 103B is adjacent to and separated from the uni-row cell 105.

FIG. 10 illustrates a cross-sectional view 1000 of a portion of a cell formed in the cell area as shown in FIG. 3 along the A-A direction in accordance with some embodiments. As shown in FIGS. 3 and 10, a first channel 312A having a first channel height C1 in the first area 302 and a corresponding source/drain terminal of a second channel 314B having a second channel height C2 in the second area 304 are commonly connected by a conductive line 332, which is electrically connected to a conductive via 334. The conductive via 334 is electrically connected to a power line (VDD or VSS). The second channel height C2 is greater than the first channel height C1, and the conductive via 334 is placed adjacent to, partially over, or directly over the second channel 314B. As shown in FIGS. 3 and 10, a first distance between a vertical center of the first channel 312A and a vertical center of the conductive via 334 is D1, a second distance between a vertical center of the second channel 314B and the vertical center of the conductive via 334 is D2, and D2 is smaller than D1. The placement of the conductive via 334 adjacent to the channel (e.g., the second channel 314B) with wider height can advantageously improve the electrical connection between the shared channels (e.g., 312A and 314B) and the power line.

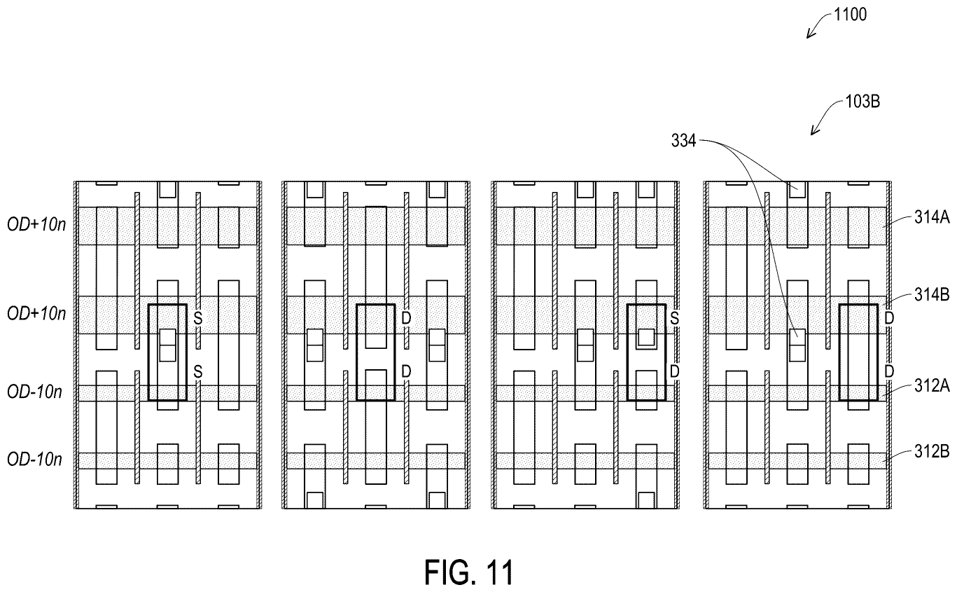

FIG. 11 illustrates a schematic diagram 1100 that shows placements of conductive vias in a plurality of cell areas included in the integrated circuit layout of FIG. 1 in accordance with some embodiments. As shown in FIG. 11, source on a smaller channel or OD (e.g., 312A) side comes from a larger channel or OD (e.g., 314B) side. In some embodiments, an HBO cell may share source from a larger channel or OD (e.g., 314B) side to a smaller channel or OD (e.g., 312A) side.

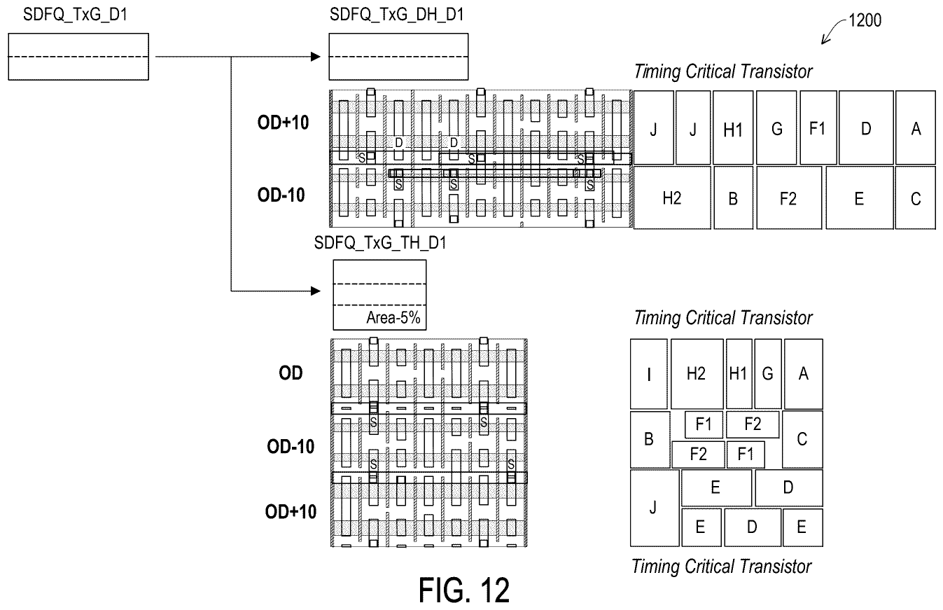

FIG. 12 illustrates a schematic diagram 1200 of an example integrated circuit layout for an example circuit, such as a Scan D Flip Flop (SDFQ) circuit, at a certain metallization level in accordance with some embodiments. As shown in FIG. 12, in a block “SDFQ_TxG_DH_D1” of the SDFQ circuit, timing critical transistors such as I, J, H1, G, F1, D and A are respectively placed in cell areas with larger OD sizes or channel heights (e.g., OD+10 nm), while in the same block “SDFQ TxG_DH D1” of the SDFQ circuit, other non-timing critical transistors such as H2, B, F2, E and C are respectively placed in cell areas with smaller OD sizes or channel heights (e.g., OD−10 nm). As such, a SDFQ feedback loop is allowed to be on a smaller OD side for example.

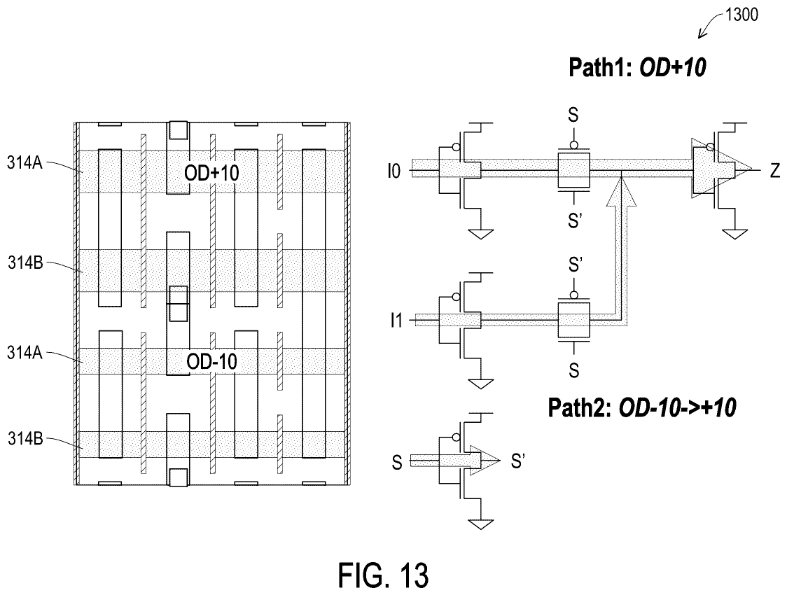

FIG. 13 illustrates a schematic diagram 1300 of another example integrated circuit layout for another example circuit, such as a transmission gate (TxG) circuit, at a certain metallization level in accordance with some embodiments. Since a hybrid cell design with hybrid ODs is adopted, tools can select whether using a high speed arc or a low power arc, and improved average speed with lower power can be achieved.

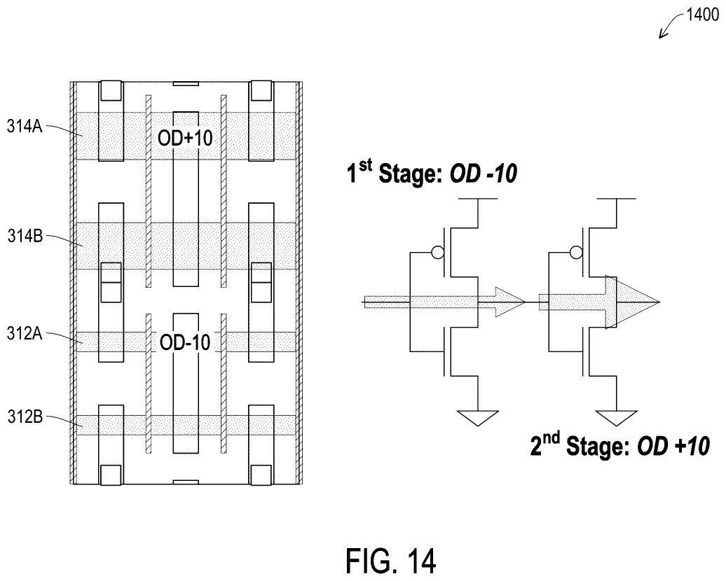

FIG. 14 illustrates a schematic diagram 1400 of still another example integrated circuit layout including multi-stage cells at a certain metallization level in accordance with some embodiments. Since a hybrid cell design with hybrid ODs is adopted, multi-stage cells can advantageously tune the first stage OD width (e.g., OD−10 nm) and the second stage OD width (e.g., OD+10 nm) in order to obtain a better stage ratio, thereby improving the circuit performance.

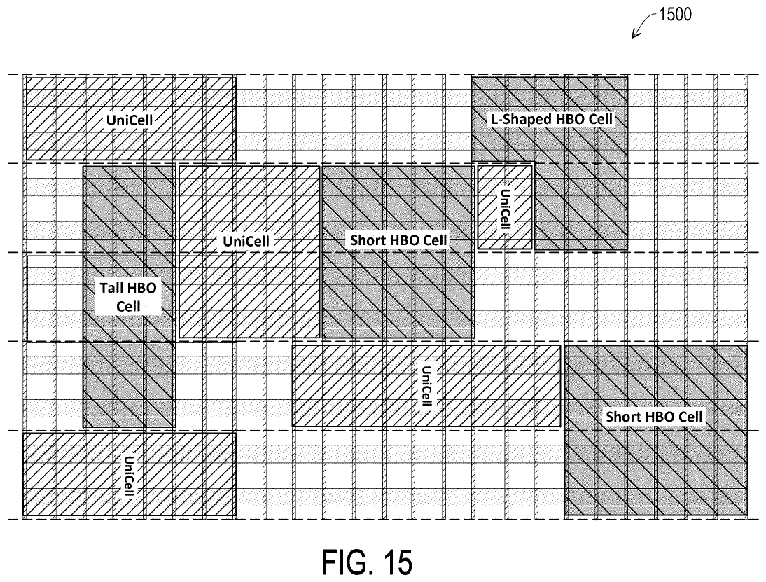

FIG. 15 illustrates a schematic diagram of an example integrated circuit layout 1500 including a combination of HBO cells and uni-row cells in accordance with some embodiments. An HBO cell has a multi-cell height cell structure in which in-cell OD width can be adjusted. As shown in FIG. 15, an HBO cell can abut a uni-row cell, an HBO cell should be at least two times of a height of a uni-row cell, and various combinations of uni-row cells, tall HBO cells, short HBO cells, and L-shaped HBO cells can offer more selections for better speed and power performance.

In one aspect of the present disclosure, an integrated circuit layout is provided. The integrated circuit layout includes a cell area including a plurality of cell rows extending along a first direction, each of the plurality of cell rows having a uniform row height along a second direction perpendicular to the first direction. The cell area consists of a first area including a plurality of first channels of p-type and n-type extending across the cell area along the first direction and separated from each other along the second direction, each of the plurality of first channels having a first channel height along the second direction; and a second area directly abutting the first area along the second direction, and including a plurality of second channels of p-type and n-type extending across the cell area along the first direction and separated from each other along the second direction. Each of the plurality of second channels having a second channel height different from the first channel height along the second direction.

In another aspect of the present disclosure, an integrated circuit layout is provided. The integrated circuit layout includes a space arranged for an integrated circuit layout, and a cell area arranged in the space. The cell area includes a plurality of cell rows extending along a first direction and each having a uniform row height along a second direction perpendicular to the first direction. The cell area consists of a first area including a plurality of first channels completely extending across the cell area along the first direction and separated from each other along the second direction, each of the plurality of first channels having a first channel height along the second direction; and a second area directly abutting the first area along the second direction, and including a plurality of second channels partially extending across the cell area along the first direction and separated from each other along the second direction. Each of the plurality of second channels has a second channel height different from the first channel height along the second direction.

In yet another aspect of the present disclosure, an integrated circuit layout is provided. The integrated circuit layout includes a space arranged for the integrated circuit layout; a first cell area arranged in the space and including a first plurality of cell rows extending along a first direction and each having a uniform row height along a second direction perpendicular to the first direction; and a second cell area arranged in the space and including a second plurality of cell rows extending along the first direction and each having the uniform row height along the second direction. The first cell area consists of a first area including a plurality of first channels of p-type and n-type extending along the first direction and separated from each other along the second direction, each of the plurality of first channels having a first channel height along the second direction; and a second area directly abutting the first area along the second direction, and including a plurality of second channels of p-type and n-type extending along the first direction and separated from each other along the second direction, each of the plurality of second channels having a second channel height greater than the first channel height along the second direction.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An integrated circuit layout, comprising:
a cell area comprising a plurality of cell rows extending along a first direction, each of the plurality of cell rows having a uniform row height along a second direction perpendicular to the first direction, wherein the cell area consists of:
a first area comprising a plurality of first channels of p-type and n-type extending across the cell area along the first direction and separated from each other along the second direction, each of the plurality of first channels having a first channel height along the second direction; and
a second area directly abutting the first area along the second direction, and comprising a plurality of second channels of p-type and n-type extending across the cell area along the first direction and separated from each other along the second direction, each of the plurality of second channels having a second channel height along the second direction, the second channel height being different from the first channel height.

2. The integrated circuit layout of claim 1, wherein the second channel height is greater than the first channel height, and wherein a source/drain terminal of a first channel of the plurality of first channels in the first area and a corresponding source/drain terminal of a second channel of the plurality of second channels in the second area are commonly connected to a power line through a first conductive via that is placed adjacent to the second channel.

3. The integrated circuit layout of claim 1, wherein the second channel height is greater than the first channel height, and wherein a source/drain terminal of a first channel of the plurality of first channels in the first area and a corresponding source/drain terminal of a second channel of the plurality of second channels in the second area are commonly connected to a signal line through a second conductive via that is placed adjacent to the second channel.

4. The integrated circuit layout of claim 1, wherein the first channel height is greater than the second channel height, and wherein a source/drain terminal of a first channel of the plurality of first channels in the first area and a corresponding source/drain terminal of a second channel of the plurality of second channels in the second area are commonly connected to a power line through a first conductive via that is placed adjacent to the first channel.

5. The integrated circuit layout of claim 1, wherein the first channel height is greater than the second channel height, and wherein a source/drain terminal of a first channel of the plurality of first channels in the first area and a corresponding source/drain terminal of a second channel of the plurality of second channels in the second area are commonly connected to a signal line through a first conductive via that is placed adjacent to the first channel.

6. The integrated circuit layout of claim 1, wherein the plurality of first channels of the first area partially extending across the cell area along the first direction, and wherein the plurality of second channels of the second area completely extending across the cell area along the first direction.

7. The integrated circuit layout of claim 1, wherein the plurality of first channels of the first area completely extending across the cell area along the first direction, and wherein the plurality of second channels of the second area partially extending across the cell area along the first direction.

8. The integrated circuit layout of claim 1, wherein the first area is configured to place a plurality of first circuit modules, and wherein second area is configured to place a plurality of second circuit modules.

9. The integrated circuit layout of claim 1, wherein the plurality of first circuit modules share at least one of a first timing constraint, a first performance constraint, or a first power constraint, and the plurality of second circuit modules share at least one of a second timing constraint, a second performance constraint, or a second power constraint.

10. An integrated circuit layout, comprising:
a space arranged for an integrated circuit layout; and
a cell area arranged in the space, and comprising a plurality of cell rows extending along a first direction and each having a uniform row height along a second direction perpendicular to the first direction, wherein the cell area consists of:
a first area comprising a plurality of first channels completely extending across the cell area along the first direction and separated from each other along the second direction, each of the plurality of first channels having a first channel height along the second direction; and
a second area directly abutting the first area along the second direction, and comprising a plurality of second channels partially extending across the cell area along the first direction and separated from each other along the second direction, each of the plurality of second channels having a second channel height along the second direction, the second channel height being different from the first channel height.

11. The integrated circuit layout of claim 10, wherein the plurality of first channels have p-type and n-type, and the plurality of second channels have p-type and n-type.

12. The integrated circuit layout of claim 10, wherein the second channel height is greater the first channel height.

13. The integrated circuit layout of claim 10, wherein the first channel height is greater the second channel height.

14. The integrated circuit layout of claim 10, wherein the second channel height is greater than the first channel height, and wherein a source/drain terminal of a first channel of the plurality of first channels in the first area and a corresponding source/drain terminal of a second channel of the plurality of second channels in the second area are commonly connected to a power line through a first conductive via that is placed adjacent to the second channel.

15. The integrated circuit layout of claim 10, wherein the second channel height is greater than the first channel height, and wherein a source/drain terminal of a first channel of the plurality of first channels in the first area and a corresponding source/drain terminal of a second channel of the plurality of second channels in the second area are commonly connected to a signal line through a second conductive via that is placed adjacent to the second channel.

16. A method of generating an integrated circuit layout, comprising:
receiving a design of an integrated circuit;
identifying, from the design of the integrated circuit, a first circuit module of the integrated circuit based on either a user specification or a first common characteristic;
arranging, based on the identified first circuit module circuit module, a first cell area relative to a space arranged for the design of the integrated circuit, the first cell area comprising a first plurality of cell rows extending along a first direction and each having a uniform row height along a second direction perpendicular to the first direction, wherein the first cell area consists of:
a first area comprising a plurality of first channels of p-type and n-type extending along the first direction and separated from each other along the second direction, each of the plurality of first channels having a first channel height along the second direction; and
a second area directly abutting the first area along the second direction, and comprising a plurality of second channels of p-type and n-type extending along the first direction and separated from each other along the second direction, each of the plurality of second channels having a second channel height along the second direction, the second channel height being greater than the first channel height.

17. The method of claim 16, further comprising:
placing, into the first cell area, a set of first standard cells.

18. The method of claim 16, further comprising:
determining at least one of a first timing constraint, a first performance constraint, or a first power constraint corresponding to the first circuit module of the integrated circuit to identify the first circuit module.

19. The method of claim 16, further comprising:
identifying, from the design of the integrated circuit, a second circuit module of the integrated circuit based on either the user specification or a second common characteristic;
arranging, based on the identified second circuit module circuit module, a second cell area relative to the space, the second cell area comprising a second plurality of cell rows extending along a first direction and each having the uniform row height along the second direction, wherein the second cell area consists of:
a third area comprising a plurality of third channels of p-type and n-type extending along the first direction and separated from each other along the second direction, each of the plurality of third channels having a third channel height along the second direction; and
a fourth area directly abutting the third area along the second direction, and comprising a plurality of fourth channels of p-type and n-type extending along the first direction and separated from each other along the second direction, each of the plurality of fourth channels having a fourth channel height greater than the third channel height along the second direction.

20. The method of claim 19, further comprising:
placing, into the second cell area, a set of second standard cells.
